(19) United States
(12) Patent Application Publication
(10) Pub. No.: US 2023/0081456 A1
(43) Pub. Date: Mar. 16, 2023

(54) PROCEDURES TO ENABLE INTRA-BAND COEXISTENCE BETWEEN NEW RADIO VEHICLE-TO-EVERYTHING (V2X) AND LONG TERM EVOLUTION V2X

(71) Applicant: Samsung Electronics Co., Ltd., Gyeonggi-do (KR)

(72) Inventors: Yaser Mohamed Mostafa Kamal FOUAD, San Jose, CA (US); Phillip Sartori, Naperville, IL (US)

(21) Appl. No.: 17/892,517

(22) Filed: Aug. 22, 2022

Related U.S. Application Data
(60) Provisional application No. 63/245,018, filed on Sep. 16, 2021.

(51) Int. Cl. H04W 74/08

(52) U.S. Cl. CPC H04W 74/0858; H04W 74/085; H04W 74/0866

(57) ABSTRACT

Disclosed is a method for long term evolution (LTE) carrier determination by a new radio user equipment (NR UE), including determining whether an LTE carrier includes unused resources for data transmission, in response to determining the LTE carrier includes the unused resources, performing a collision determination, the collision determination being based at least in part on a randomized likelihood that transmissions of the NR UE on the LTE carrier will collide with transmission of one or more other NR UEs on the LTE carrier, and based on the collision determination, performing a transmission delay, the transmission delay occurring during a random back off period duration.

### PRIORITY

This application is based on and claims priority under 35 U.S.C. § 119(e) to U.S. Provisional Application Ser. No. 63/245,018, which was filed in the U.S. Patent and Trademark Office on Sep. 16, 2021, the contents of which are incorporated herein by reference.

### FIELD

The disclosure relates generally to Vehicle-to-Everything (V2X) transmission, and more particularly, to procedures enabling intra-band coexistence between new radio (NR) V2X and long term evolution (LTE) V2X transmission.

### BACKGROUND

LTE V2X and related technologies provide various paradigms for enabling communications between nearby vehicles. These communication links allow vehicles to exchange basic safety messages to either avoid potential accidents or to enhance the user experience by sharing real-time road characteristics (e.g., traffic). Such applications will allow a large adoption of LTE V2X between many vendors. However, some major drawbacks of LTE V2X are that it is designed only for periodic traffic and that it offers limited data rates. To address these drawbacks, new radio (NR) third generation partnership project release 16 (NR 3GPP Rel-16) V2X offers support for aperiodic traffic and data rate enhancements to offer support for a wider variety of applications. NR Rel-16 and release 17 (Rel-17) communication standards will operate concurrently with LTE V2X on a separate band to widen the range of supported V2X applications.

Given the nature of basic safety messages, the LTE V2X spectrum may not be fully occupied at any given instance. In one particular use case, when the regulator assigns a spectrum, such as 30 megahertz (MHz), for V2X safety services. In such a case, there are areas where the spectrum will end up being under-utilized. To address this drawback, one possible solution is to allow the coexistence between LTE and NR on the same operating band so that the NR can harvest the unutilized spectrum by the LTE. However, given the nature and importance of the basic safety messages carried by the LTE, it is important that the performance of LTE should not be affected by the NR. In addition, some legacy devices will support only LTE V2X configurations, and thus they are often will not detect the presence of NR. For these reasons, it is important that LTE V2X should be able to operate independently from the NR V2X (i.e., the NR should be transparent to LTE).

To achieve this goal, several proposals were made by multiple vendors and operators for NR Rel-18 to enable the coexistence between NR and LTE systems in the same band with minimal impact on LTE. For example, one proposal suggests that to support the coexistence in the Rel-18 workshop, LTE will support basic use cases (safety) and NR will support advanced used cases. This can be done by enabling coexistence to achieve ‘tiered-down’ services while intelligent transport systems (ITS) spectrum allocations are being decided, such that new services can utilize NR V2X's high spectral efficiency and HARQ feedback, and LTE/NR dynamic spectrum sharing can be designed to protect the LTE-V2X.

Such coexistence can also maximize the deployment flexibility and enable new technology migration paths, thereby enabling the eventual transition from LTE to NR. Moreover, in co-channel deployments, the new services availability over a localized area will be tiered and dynamic and will be based on LTE V2X penetration and vehicle density.

In current proposals, it can be inferred that coexistence will be achieved by NR detecting future periodic reservations by LTE and identifying these reservations as being occupied, and NR performing Mode 2 resource selection over the remaining grid of resource blocks (RBs). However, although detecting LTE future reservations will help avoid collisions with future periodic traffic, no protection will be offered for newly incoming LTE traffic as NR will not be aware of these devices, resulting in degraded LTE performance. In addition, NR will be unable to send traffic in resources already occupied by LTE even if they have higher priority, and LTE can disrupt the future reservations of NR, thus creating a need for enhanced Mode-2 like operation.

In Rel-16, LTE and NR in-device coexistence is supported. In particular, a user equipment (UE) is assumed to have LTE and NR capabilities and there exists a subframe boundary alignment between LTE and NR V2X sidelinks, and both LTE and NR V2X sidelinks are aware of the time resource index, such as a direct frame number (DFN) for LTE, in both carriers. Subsequently, the UE is allowed to have short term time division multiplexing (TDM) coexistence between the LTE and NR sidelink (SL) on different carriers. In particular, the following cases were considered in case of transmission/transmission (Tx/Tx), reception/reception (Rx/Rx), and Tx/Rx overlap between the two sidelinks.

For Tx/Tx overlap, if packet priorities of both LTE and NR SL transmissions are known to both RATs prior to time of transmission subject to processing time restriction, the packet with a higher relative priority is transmitted. In case the priorities of LTE and NR SL transmissions are the same, the UE implementation dictates which transmission is chosen, such as by considering congestion and other related factors. If packet priorities of both LTE and NR SL transmissions are not known to both RATs prior to the time of transmission subject to processing time restriction, the UE implementation manages Tx/Tx overlaps.

For Rx/Rx overlap, UE implementation dictates how reception of LTE and NR SLs is managed.

For Tx/Rx overlap, if packet priorities of both LTE and NR SLs are known to both RATs prior to transmission/reception subject to processing time restrictions, the packet with a higher relative priority is transmitted/received. In case the priorities of LTE and NR SL packets are identical, UE implementation dictates which packet is transmitted/received.

Subsequently, this coexistence between LTE and NR systems does not offer the flexibility in using the unutilized LTE resources by the NR SL. In particular, the coexistence is limited to enabling the UE to perform prioritization between the LTE and NR SL transmissions on different carriers (i.e., short-term TDM between the LTE and NR SLs based on priority). This prioritization also incurs processing time restrictions which can be as high as 4 ms as agreed to in RANI #102.

LTE V2X is expected to play a key role in enabling the exchange of basic safety messages between neighboring vehicles. However, current configurations of LTE V2X do not support higher data traffic rates, which limits its applications. In addition, its spectrum is often underutilized due to the limited number of basic safety messages.

Therefore, there is a need in the art for a method and apparatus enabling LTE V2X to support higher data traffic rates and enabling the coexistence of NR V2X and LTE V2X in an intra-band manner without impacting the reliability of LTE transmissions.

### SUMMARY

The present disclosure has been made to address at least the above-mentioned problems and/or disadvantages and to provide at least the advantages described below.

Accordingly, an aspect of the present disclosure is to provide a method and apparatus that enable NR V2X to support higher data traffic rates so as to expand its applications over those in the prior art.

Another aspect of the present disclosure is to provide a method and apparatus that enable NR V2X to harvest the remaining unutilized LTE V2X spectrum and to coexist on the same carrier. This improves on the prior art in which a UE performs prioritization between the LTE and NR SLs on different carriers in a TDM manner.

Another aspect of the present disclosure is to provide a method and apparatus that, in the case of co-channel coexistence between LTE and NR SLs on the same carrier, enables the NR to avoid impacting the performance of LTE V2X. To do so, the NR devices can detect both periodic and newly incoming LTE traffic and accordingly avoid the LTE resource reservations.

In accordance with an aspect of the disclosure, a method of an NR UE includes determining whether an LTE carrier includes unused resources for data transmission, in response to determining the LTE carrier includes the unused resources, performing a collision determination, the collision determination being based at least in part on a randomized likelihood that transmissions of the NR UE on the LTE carrier will collide with transmissions of one or more other NR UEs on the LTE carrier, and based on the collision determination, performing a transmission delay, the transmission delay occurring during a random back off period duration.

In accordance with an aspect of the disclosure, an NR UE includes at least one processor, and at least one memory operatively connected with the at least one processor, the at least one memory storing instructions, which when executed, instruct the at least one processor to perform a method including determining whether an LTE carrier includes unused resources for data transmission, in response to determining the LTE carrier includes the unused resources, performing a collision determination, the collision determination being based at least in part on a randomized likelihood that transmissions of the NR UE on the LTE carrier will collide with transmissions of one or more other NR UEs on the LTE carrier, and based on the collision determination, performing a transmission delay, the transmission delay occurring during a random back off period duration.

In accordance with an aspect of the disclosure, an NR UE for NR V2X transmission includes at least one processor, and at least one memory operatively connected with the at least one processor, the at least one memory storing instructions, which when executed, instruct the at least one processor to perform a method including performing energy detection on a first symbol during an LTE subframe, switching from the energy detection to an NR transmission on a second symbol or on the first symbol after the energy detection is performed, and performing the NR transmission on an NR slot for a remainder of the LTE subframe.

### BRIEF DESCRIPTION OF THE DRAWINGS

The above and other aspects, features, and advantages of certain embodiments of the present disclosure will be more apparent from the following detailed description taken in conjunction with the accompanying drawings, in which:

FIG. 1 illustrates an NR UE procedure according to an embodiment;

FIG. 2 illustrates a process for energy detection by an NR device in NR V2X, according to an embodiment;

FIG. 3 illustrates a process for energy detection by an NR device in NR V2X, according to an embodiment;

FIG. 4 illustrates a process for energy detection by an NR device in NR V2X, according to an embodiment;

FIG. 5 illustrates a process for energy detection by an NR device in NR V2X, according to an embodiment;

FIG. 6 illustrates a method of LTE physical sidelink shared channel (PSSCH) detection and energy detection, according to an embodiment;

FIG. 7 illustrates a method in an NR multi-carrier scenario according to an embodiment;

FIG. 8 illustrates a method in a multi-carrier, high spectral efficiency scenario, according to an embodiment;

FIG. 9 illustrates a process for NR future reservations overridden by LTE devices according to an embodiment;

FIG. 10 illustrates a process for time domain counting of NR future reservations according to an embodiment;

FIG. 11 illustrates a method of NR reservation in a coexistence band, according to an embodiment; and

FIG. 12 is a block diagram of an electronic device in a network environment, according to an embodiment.

### DETAILED DESCRIPTION

Embodiments of the present disclosure will be described herein below with reference to the accompanying drawings. However, the embodiments of the disclosure are not limited to the specific embodiments and should be construed as including all modifications, changes, equivalent devices and methods, and/or alternative embodiments of the present disclosure. Descriptions of well-known functions and/or configurations will be omitted for the sake of clarity and conciseness.

The expressions “have,” “may have,” “include,” and “may include” as used herein indicate the presence of corresponding features, such as numerical values, functions, operations, or parts, and do not preclude the presence of additional features. The expressions “A or B,” “at least one of A or/and B,” or “one or more of A or/and B” as used herein include all possible combinations of items enumerated with them. For example, “A or B,” “at least one of A and B,” or “at least one of A or B” indicate (1) including at least one A, (2) including at least one B, or (3) including both at least one A and at least one B.

Terms such as “first” and “second” as used herein may modify various elements regardless of an order and/or importance of the corresponding elements, and do not limit the corresponding elements. These terms may be used for the purpose of distinguishing one element from another element. For example, a first user device and a second user device may indicate different user devices regardless of the order or importance. A first element may be referred to as a second element without departing from the scope the disclosure, and similarly, a second element may be referred to as a first element.

When a first element is “operatively or communicatively coupled with/to” or “connected to” another element, such as a second element, the first element may be directly coupled with/to the second element, and there may be an intervening element, such as a third element, between the first and second elements. To the contrary, when the first element is “directly coupled with/to” or “directly connected to” the second element, there is no intervening third element between the first and second elements.

All of the terms used herein including technical or scientific terms have the same meanings as those generally understood by an ordinary skilled person in the related art unless they are defined otherwise. The terms defined in a generally used dictionary should be interpreted as having the same or similar meanings as the contextual meanings of the relevant technology and should not be interpreted as having ideal or exaggerated meanings unless they are clearly defined herein. According to circumstances, even the terms defined in this disclosure should not be interpreted as excluding the embodiments of the disclosure.

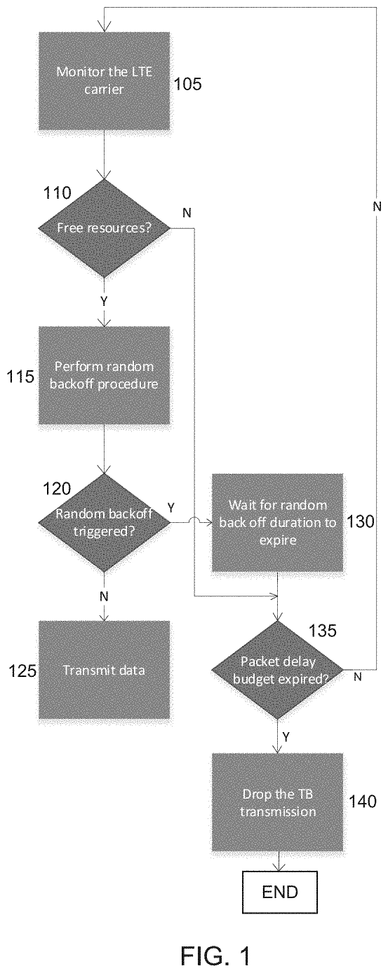

FIG. 1 illustrates an NR UE procedure 100 according to an embodiment.

In step 105, the NR UE monitors a carrier when the NR UE has data (i.e., at least one transport block (TB)) to transmit or expected to be transmitted. Particularly, when the NR UE monitors the carrier, the NR UE detects periodic and aperiodic-like LTE traffic. In order to monitor the LTE carrier, the UE needs to know the LTE carrier configuration and which carriers are available for sharing. This can be determined by (pre-)configuration using radio resource control (RRC) configuration to indicate the frequency span of each LTE carrier, whether operation for the LTE carrier is mode-3 or mode-4, whether the carrier can be shared with NR, and if yes, on which resources the carrier is shareable, and parameters for the sharing, such as priority limits and priority thresholds.

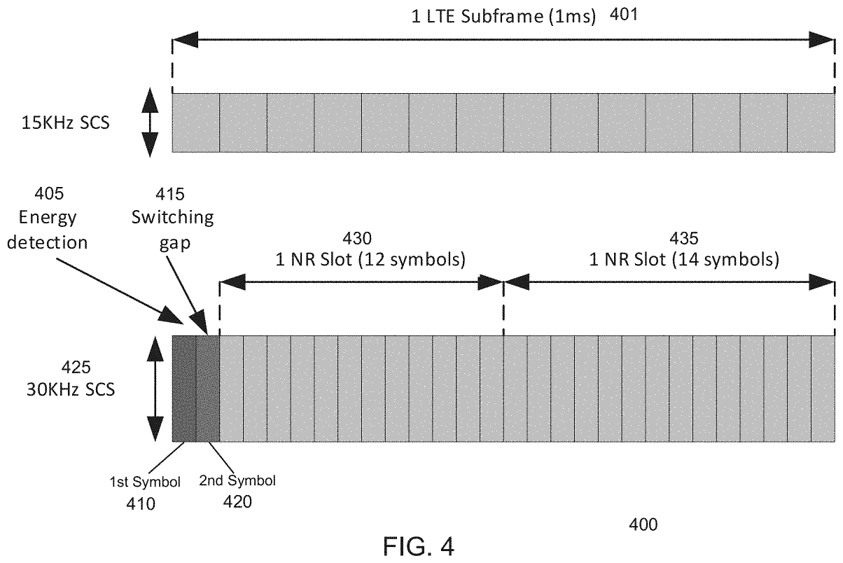

In step 110, it is determined whether free resources (i.e., available and unused resources) are found. Specifically, the NR UE senses at the beginning of the LTE subframe on the first NR slot of the LTE carrier to determine whether the LTE carrier includes the free resources. A resource is determined to be free if the measured energy during the first one or more symbols of the LTE subframe is below a pre-configured threshold. If the NR UE identifies that there is no LTE transmission on the first NR slot, the NR UE then infers that the second NR slot will be unused by an LTE user (e.g., when NR subcarrier spacing is 30 KHz) and considers the second NR slot as free. This will be described in more detail in reference to FIG. 4.

In step 115, if free resources are found, the NR UE performs a random back off by randomly determining, based on probability, whether to access media or perform a random back off action for a certain duration while still sensing the medium. The term “back off” refers generally to a time period in which a UE is unlikely to perform a transmission in order to avoid collisions with transmissions of neighboring UEs. In effect, a collision determination is performed. The time period is randomly selected by the UE from a set of given pre-configured durations. The medium refers to the UE carrier that is shared between LTE and NR UEs. The beginning of the LTE subframe refers to one or more symbols at the start of said subframe.

In step 120, it is determined whether a random back off action is triggered. For example, based on the determination in step 115, it may be determined that the UE is unlikely to perform the transmission for a given period to avoid the transmission collisions and that in response, a random back off action should be triggered for integrity of performance.

If the random back off action is triggered, the method proceeds to step 130 where the NR UE waits for the random back off duration to expire. Once expired, it is determined in step 135 whether a packet delay budget has expired. If the packet delay budget has expired, the NR UE drops the TB transmission in step 140 and the method ends. If the packet delay budget has not expired, the method re-starts by returning to step 105.

Specifically, sensing and resource selection are performed when there is data to transmit in sidelink. The selected resources will then be transmitted at a future slot which is either selected or reserved by a previous transmission. When the time comes for the intended slot, if there is a failure to acquire the resource (e.g., due to backoff failure), the transmission is dropped in step 140 (i.e., the TB transmission on the selected/reserved resource is skipped).

If it is determined in step 120 that the random back off action is untriggered, the UE transmits data on the carrier in step 125.

If no free resources are found in step 110, the method proceeds to above-described step 135.

Herein, the LTE carrier includes one or more LTE coexistence enabled resource pools which the NR UE uses to transmit the data based on an NR frame structure. In particular, an LTE carrier can include one or more resource pools each of which is pre-configured separately. In each of these resource pools, it is likely that coexistence can be either enabled or disabled based on one or more pre-configured parameters (e.g., priority, channel occupancy). In this case, if coexistence is enabled, NR UEs will have access to the resources configured for the resource pool if they are not occupied by LTE UEs and can accordingly transmit following a pre-configured NR frame structure that is different from that of the LTE (e.g., the NR UE can transmit with a 30 KHz subcarrier spacing).

It has been discussed regarding NR release 18 (Rel-18) that V2X devices can be assumed to have both NR and LTE V2X capabilities. Subsequently, these devices will be able to detect future periodic reservations by LTE and accordingly avoid them. Despite the advantages of this technique, it suffers from two major drawbacks. New LTE periodic reservations will not be detected, and thus, will be vulnerable to collisions with NR. This impact is also magnified by the expected high mobility of vehicles. In addition, a resource that is released by an LTE device will still be considered as reserved by NR devices and subsequently will be avoided. To address this drawback, an energy-detection based avoidance mechanism to enable NR devices to detect and avoid LTE reservations is disclosed. In particular, an NR device can perform energy detection on one or more symbols at the beginning of each subframe and thereby determine whether to access this resource.

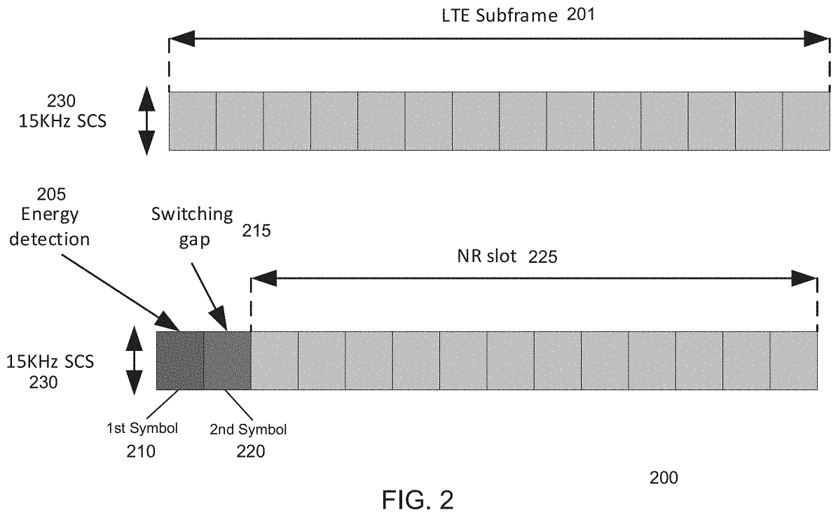

FIG. 2 illustrates a process 200 for energy detection by an NR device in NR V2X, according to an embodiment. Specifically, the energy detection in FIG. 2 is performed by the NR V2X devices to avoid collisions with LTE V2X reservations.

In FIG. 2, an NR device performs energy detection 205 (i.e., sensing) on the first symbol 210, switches from the energy detection 205 in the switching gap 215 on a second symbol 220 and performs NR transmission on the NR slot 225 for the remainder of the LTE subframe 201, such as the illustrated 12 remaining orthogonal frequency division multiplexing (OFDM) symbols in the NR slot 225 based on the 15 kilohertz (KHz) subcarrier spacing (SCS) 230.

This sensing can be used to enable further protection to LTE devices when considered in addition to the detected periodic reservations by LTE, which reduces the likelihood of collisions with LTE aperiodic-like traffic (i.e., the beginning of the periodic reservations by LTE). Alternatively, this sensing can be used to achieve better utilization by reusing the resources blocked by the LTE periodic reservations if no energy is detected.

NR devices should perform energy detection 205 at the beginning of each LTE subframe 201 to determine whether the above resource is occupied by an LTE V2X device. The energy detection 205 is performed on the first symbol 210 and followed by the switching gap 215 on the second symbol 220 before the NR slot 225 begins.

To further reduce the chances of collisions between NR devices and LTE V2X devices, the energy detection 205 can be considered in addition to detected future reservations by LTE to offer protection for aperiodic-like LTE reservations. Energy detection 205 can also be used to enable access to resources reserved by the periodic transmissions of LTE if the detected energy level is low, thus enabling a better utilization of the available resources. To reduce the sensing overhead of the energy detection 205 in FIG. 2, sensing is performed in a larger SCS (e.g., 15 KHz SCS 230) for a duration equal to half a symbol, and the remaining symbol is used for switching, thus reducing the overhead.

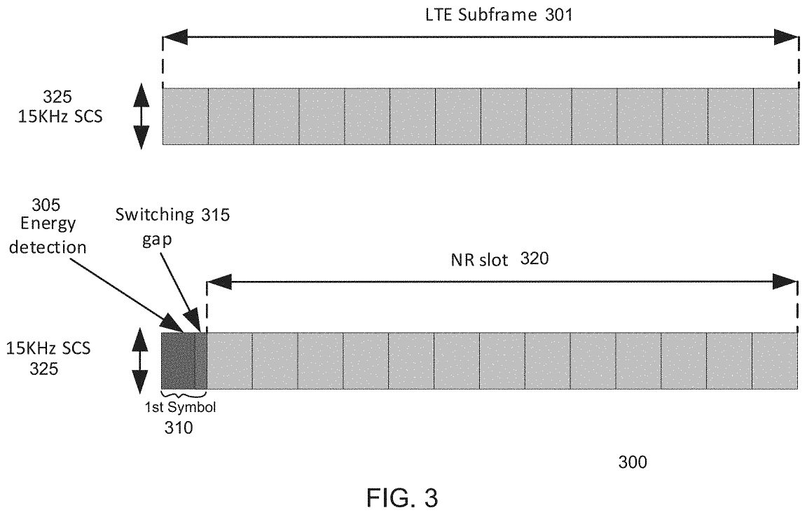

FIG. 3 illustrates a process 300 for energy detection by an NR device in NR V2X, according to an embodiment. In FIG. 3, energy detection 305 and a switching gap 315 are combined in the first symbol 310 of an LTE subframe 301 for the 15 KHz SCS 325.

Specifically, in FIG. 3, 15 KHz SCS 325 is considered and the UE performs energy detection 305 for a duration such as 51 Microseconds (51 μs) followed by a switching duration such as 20 μs in the switching gap 315 before the NR slot 320 begins. These durations may vary based on system configuration.

FIG. 4 illustrates a process 400 for energy detection by an NR device in NR V2X, according to an embodiment. In FIG. 4, energy detection 405 and a switching gap 415 are provided in an NR configured with multiple slot sizes to improve efficiency. That is, for larger 30 KHz SCS 425, the NR system can be configured with multiple symbols per slot, thereby enabling the UE to perform energy detection 405 only in the first symbol 410 within the subframe by using 12 OFDM symbols per slot 430 while operating with up to 14 OFDM symbols per slot 435 for the remainder of the NR subframe.

In addition, a UE can operate consecutively with multiple SCSs. In other words, the UE can use a larger SCS at the beginning followed by longer SCS, such as by beginning with 120 KHZ SCS when performing sensing and then switching to 60 KHz SCS. Thus, multiple SCSs may be used within a same band for the LTE subframe and the NR slot.

The NR device can be configured to perform energy detection and switching within one symbol to improve efficiency. The NR devices can be configured with two or more number of symbols per slot for each resource pool. An NR device can use the slot duration with fewer symbols in the slots within which the energy detection is performed.

With these schemes, a new NR SL slot needs to be defined. While this is not anticipated to be a significant issue since it simply consists of extending the existing NR enhanced mobile broadband (eMBB) framework to the sidelink, a less efficient solution is also possible. When NR UE uses a different SCS than LTE, an LTE slot comprises multiple NR slots. Thus, the NR transmission can always begin at the beginning of an existing NR slot. Assuming that the NR SCS is 30 KHz, an LTE slot then corresponds to two NR slots. Then, the NR UE senses at the beginning of the LTE slot during the first NR slot, in the manner of the above processes.

If the NR UE assesses that there is no LTE transmission on the first NR slot, the NR UE can infer that the second NR slot will be unused by an LTE user and then considers the second slot as being free and attempts to use it. This is described above in reference to FIG. 1.

It is noted that this technique can be performed even if the NR UE is unable to receive or monitor LTE signals as long as the NR UE is aware of the LTE synchronization. This information can be communicated by RRC signaling. For instance, an NR RRC message can indicate that the sidelink LTE UEs are synchronized using the global navigation satellite system (GNSS) as the primary synchronization source. In this case, the NR can align the slot boundaries with that of the LTE subframes to ensure that there are no power leakages across subframes.

Whether the sensing is full slot, half slot, one or more symbols, or a partial symbol can be (pre-)configured by RRC signaling. Similarly, whether transmission is constrained to start at the beginning of an NR slot or can partially occupy an NR slot can be (pre-)configured by RRC signaling.

To preserve the power consumed by the energy detection technique, the following two processes can be considered.

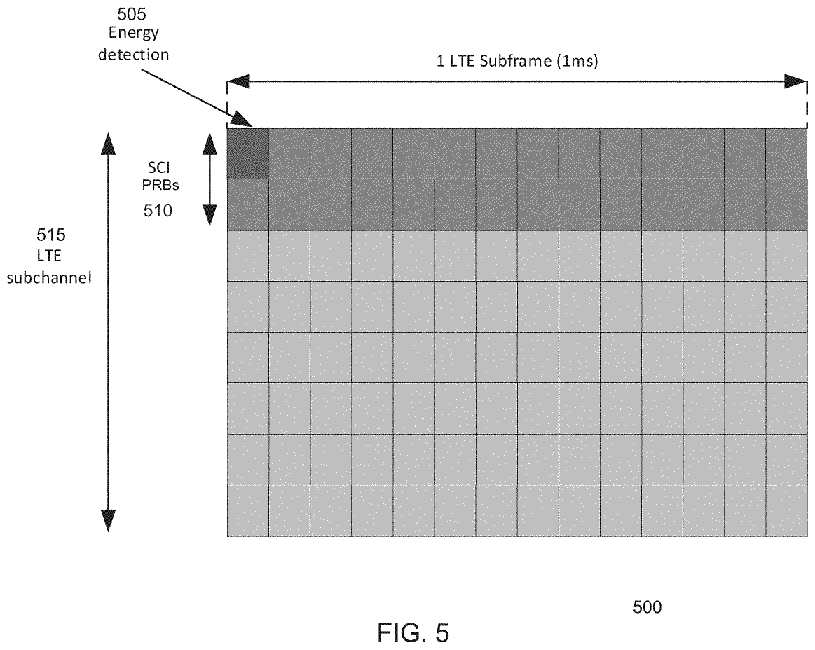

FIG. 5 illustrates a process 500 for energy detection by an NR device in NR V2X, according to an embodiment. Specifically, an NR UE can perform its energy detection 505 in the subcarriers 515 dedicated for sidelink control information (SCI) transmissions by LTE devices or a subset 510 of these devices. That is, the NR can be configured to monitor only the 2 physical resource blocks (PRBs) 510 that are occupied by the LTE SCI or assigned for transmissions within each LTE subchannel 515, thus reducing the bandwidth that needs to be monitored.

In an alternative process, a UE can be configured to skip the energy detection on the subchannels already reserved by LTE periodic reservations and consider those subchannels as being occupied. In addition, NR devices can also skip the energy detection on the future resources that are reserved by their neighboring NR devices to preserve power. The selected technique can be hardcoded, (pre-)configured by RRC signaling, or performed per resource pool. For example, an NR resource pool that is configured to accommodate only full sensing UEs can be required to monitor more of the LTE RBs when compared to another NR resource pool that is configured to accommodate partial sensing UEs (i.e., power saving UEs).

In some cases, an NR device will not be able to detect LTE reservation due to the half-duplex constraint. For example, a UE can transmit during this subframe and thus will be unable to detect the LTE SCI. To resolve this issue, one possible approach is to follow that of LTE Mode 4. In particular, a hypothetical SCI can be assumed to be received during this subframe; accordingly, subsequent subframes based on all possible periods are initially excluded. Subsequently, after energy detection, a UE can determine whether to use these slots. Another possible approach is to consider the NR transmission priority when handling these excluded subframes based on the hypothetical SCI. For instance, an NR UE with high priority can be allowed to access either all or a subset of these resources. The exclusion can be based only on a subset of the subchannels that were unused by the NR device for transmission. In other words, when excluding the LTE subframes based on all the possible periods, an NR UE excludes only the subchannels within these slots in which the NR UE did not transmit, since it is highly likely that these resources were unused by a neighboring LTE device.

The sensing of occupied resources can be performed based on LTE PSSCH decoding and/or energy detection. For instance, an NR UE assumes that an LTE subframe is free for NR transmission only if no LTE SCI indicates transmissions in that particular subframe, due to either a current SCI or previous reservation, and/or no energy is detected above a pre-configured threshold level on the LTE subframe. Note that this threshold can be dependent on priority.

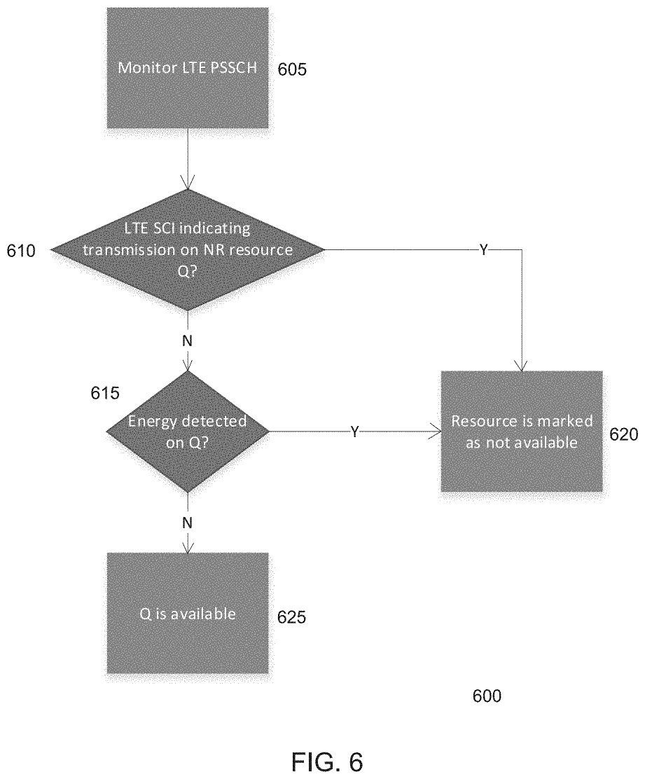

FIG. 6 illustrates a method of LTE physical sidelink shared channel (PSSCH) detection and energy detection, according to an embodiment. Specifically, the method of FIG. 6 is performed when the above two conditions are required for extra protection to LTE devices, i.e., when no LTE SCI indicates transmission in a particular subframe and no energy detection occurs on the LTE subframe.

In step 605, the UE monitors the LTE PSSCH.

In step 610, it is determined whether the LTE SCI indicates transmission on an NR resource Q. If the LTE SCI does not indicate transmission on an NR resource Q, the method proceeds to step 615 in which it is determined whether energy is detected on the NR resource Q. If no energy is detected on the NR resource Q, it is determined in step 625 that Q is available.

If it is determined in step 610 that the LTE SCI indicates transmission on an NR resource Q, the method proceeds to step 620 in which the NR resource Q is marked as being unavailable. In addition, if energy is detected on the NR resource Q in step 615, the NR resource Q is marked as being unavailable in step 620.

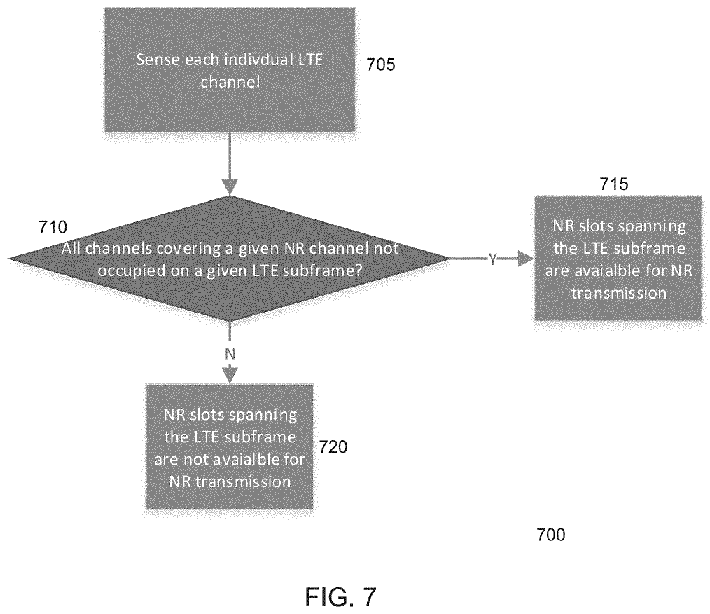

FIG. 7 illustrates a method in an NR multi-carrier scenario according to an embodiment. The bandwidths of an NR subchannel and LTE subchannel can be different.

In step 705, assuming that an NR subchannel partially or fully covers k LTE subchannels, the NR UE senses each individual LTE subchannel.

In step 710, it is determined whether all of the LTE subchannels covering a given NR channel are occupied on a given LTE subframe, or in other words, are deemed as free.

In step 715, if the LTE subchannels are deemed as free, the NR slots spanning the LTE subframe are then indicated as being available for transmission.

If it is determined in step 710 that the LTE subchannels covering the given NR channel are not occupied over a given LTE subframe, then in step 720, these NR slots spanning the LTE subframe are deemed unavailable for NR transmission.

Another solution is to have NR transmissions only on the RBs located in LTE channels that are unoccupied, which may be a more spectrally efficient solution.

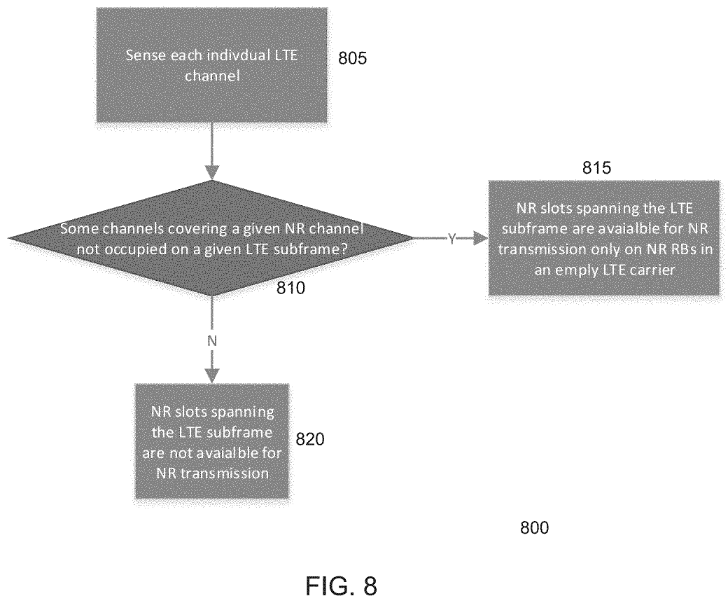

FIG. 8 illustrates a method 800 in a multi-carrier, high spectral efficiency scenario, according to an embodiment.

In step 805, each individual LTE channel is sensed.

In step 810, it is determined whether some channels covering a given NR channel are not occupied on a given LTE subframe.

If it is determined in step 810 that some of the channels covering the given NR channel are occupied on a given LTE subframe, then in step 815, NR slots spanning the LTE subframe are indicated as being available for NR transmission only on NR RBs in an empty LTE carrier.

If it is determined in step 810 that some of the channels covering the given NR channel are not occupied on a given subframe, then in step 820, NR slots spanning the LTE subframe are indicated as being unavailable for NR transmission.

It is possible to configure the NR UE to operate in one of these two modes in the multi-carrier case by an RRC parameter.

When an NR subchannel overlaps with more than one LTE subchannel, all the LTE subchannels must be declared as unoccupied before the NR can transmit on the overlapping subchannels. To avoid resource underutilization, an NR UE may be allowed to transmit on a subset of RBs belonging to the NR subchannel that is unoccupied by the LTE devices.

NR devices are typically avoid using the resources occupied by LTE V2X devices in order for the reliability of these LTE V2X devices to be maintained. However, an issue arises when there exists a large number of NR devices attempting to access a limited number of leftover resources by the LTE V2X, such that the average number of NR devices attempting to reserve one subchannel/slot at a given slot is larger than (e.g., 50%) of the number of available NR subchannels. For instance, if only 5 available transmission resources exist for 10 NR devices, the chances of collisions between these devices will be high. The chances of collisions also increases when the number of available resources for NR transmissions are separated by more than 31 slots such that future reservations cannot be signaled beforehand. It is noted that 31 slots is the maximum possible scheduling window for NR Rel-16 and Rel-17. In other words, an NR UE can reserve aperiodic resources in a slot that is a maximum 31 slots away from the current slot.

To address this drawback, an approach is to rely on a random back off mechanism. In particular, when an NR UE with data detects that a subchannel is available for transmission that is not reserved by any other NR or LTE device, the NR UE uses the subchannel with a probability p and backs off with probability 1-p. The value of p can depend on the following parameters.

The higher the UE priority, the higher the value of p since the UE should be a given a higher chance of transmission.

If the channel busy ratio (CBR) is high, i.e., if the number of occupied LTE resources is high, the system is heavily loaded and the chances of collisions increases. Hence, the higher the occupancy level, the less the value of p.

The larger the number of subchannels needed for transmission, the higher the chances a UE will be colliding with other NR devices. Thus, the UE should have a lower probability for transmission p.

The higher the packet delay budget, the more tolerant the UE is to delays and thus should have a lower probability for transmission p.

A UE that backed off multiple times during a pre-defined past duration should have a higher probability for transmission p. When the duration between the currently available resource and the last available resource increases, the number of UEs likely to transmit also increases and thus the probability for transmission p should be reduced.

If the resource is previously reserved by an NR device, the UE which performed this reservation transmits with probability p=1 if the UE is not pre-empted while other UEs have a probability of p=0 or p<1 for transmitting.

The value of p and the dependency relations with other parameters can be (pre-)configured by RRC signaling. In particular, a configuration parameter that can be provided by RRC signaling can include the contribution of each parameter to the value of p. It can also enable/disable the impact of one or more parameters on the value of p.

In another approach, UEs with different priorities can be assigned different energy detection durations. For instance, low priority NR UEs can be required to perform energy detection over two OFDM symbols whereas high priority NR UEs can be required to perform energy detection over half an OFDM symbol. In this case, the instance when the high priority device starts to transmit, their energy will be detected and the low priority UEs will not perform a transmission.

To avoid collisions between NR devices when accessing the available resource, a random-back off based approach can be considered whereby the UEs attempt to access the available subchannels with priority p. The value of priority p can be dependent on multiple parameters such as UE priority, the number of back offs in a past duration, LTE occupancy (e.g., CBR), the number of required subchannels, packet delay budget, whether the resource is reserved by the NR UE, and duration between the current resource and the last available resource.

To avoid collisions between NR devices, these devices can be assigned different durations for energy detection based on their priorities, whereby the NR devices with the highest priority have the shortest energy detection duration.

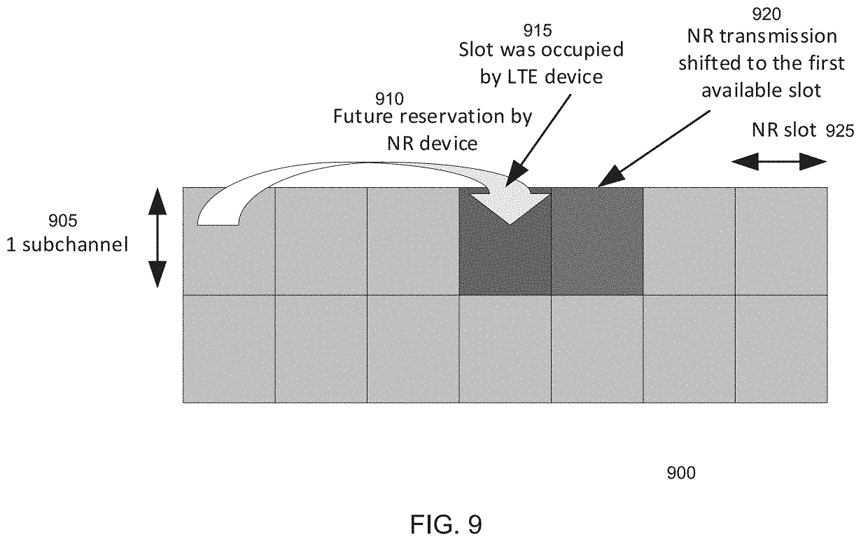

FIG. 9 illustrates a process 900 for NR future reservations overridden by LTE devices according to an embodiment. Specifically, in a subchannel 905, a future NR reservation 910 of an NR slot 925 by an NR device is shifted to the first available resource 920 when the reserved resource is overridden by an LTE aperiodic-like reservation, or in other words, when the slot was occupied by an LTE device 915.

Specifically, NR devices can detect when future resources are unoccupied by an LTE periodic reservation and accordingly reserve these resources for future transmission. This reservation is detected by neighboring NR devices; therefore, the neighboring NR devices will not attempt to access this resource. However, as previously discussed, LTE devices can still attempt to access this resource for aperiodic-like transmissions because they are unaware of the reservations performed by the NR devices. Subsequently, the NR device will be unable to transmit after detecting the energy of the LTE device.

To avoid collisions between NR devices in this instance, the overridden NR device will be allowed to transmit in the next available resource 920. In other words, the reservation performed by NR devices will be shifted by the number of overridden resources by LTE devices (i.e., aperiodic-like reservation by an LTE device). When the reservation covers multiple subchannels, the reservation can be performed either subchannel by subchannel or can be shifted to the next available resource 920 with the same number of subchannels.

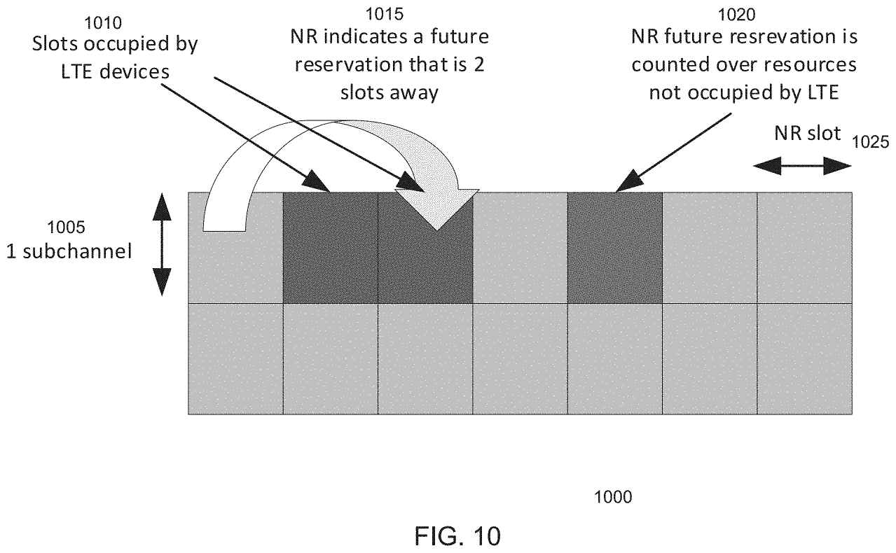

FIG. 10 illustrates a process 1000 for time domain counting of NR future reservations according to an embodiment. In FIG. 10, the NR future reservations are based only on the resources unoccupied by LTE 1020. Resources occupied by LTE 1010 are considered as being outside of the NR resource pool.

That is, to reduce the number of collisions between neighboring NR devices especially when the available resources are more than 31 slots apart, one possible approach is to consider the resources reserved by LTE devices 1010 as being outside of the resource pool from the time domain perspective. For example, when an NR UE signals a future reservation that is 10 slots away, these 10 slots will be counted over slots that are unoccupied by LTE devices. This signaled slot can be 20 slots away if 10 slots are occupied by LTE devices before the next reservation. In FIG. 10, the NR UE signals a future reservation that is 2 slots away 1015; thus, these two slots are counted over resources unoccupied by LTE devices 1020.

This time-domain counting can be performed on a subchannel-by-subchannel basis. In this case, a UE that reserved multiple subchannels can end up relinquishing the reserved resources if only a subset of the subchannels is available or the UE can elect to transmit a smaller transport block (TB). Alternatively, the time-domain counting can be incremented by 1 only when all the reserved subchannels are unoccupied by LTE devices. This skipping of resources that are occupied by LTE 1010 from the NR resource pool can be configured by RRC signaling, can be enabled/disabled depending on the system occupancy (e.g., CBR), and can be disabled when the CBR is large, such as when the CBR is above a pre-configured threshold.

To reduce the complexity, one less spectral-effective but simpler solution is to disable the use of reservation for NR UEs. In other words, a UE operating on a shared LTE-NR carrier may not perform reservations for future transmissions.

As previously discussed, NR devices often avoid using the resources occupied by LTE V2X devices so that the reliability of the LTE V2X devices is not compromised. In some scenarios, however, NR devices may have a high priority or a limited delay budget such that it would be beneficial to have a future reservation that is detectable by LTE. In other words, if the future reservation of NR can be propagated to LTE, a higher quality of service can be provided for NR devices with higher priority or minimal packet delay budget.

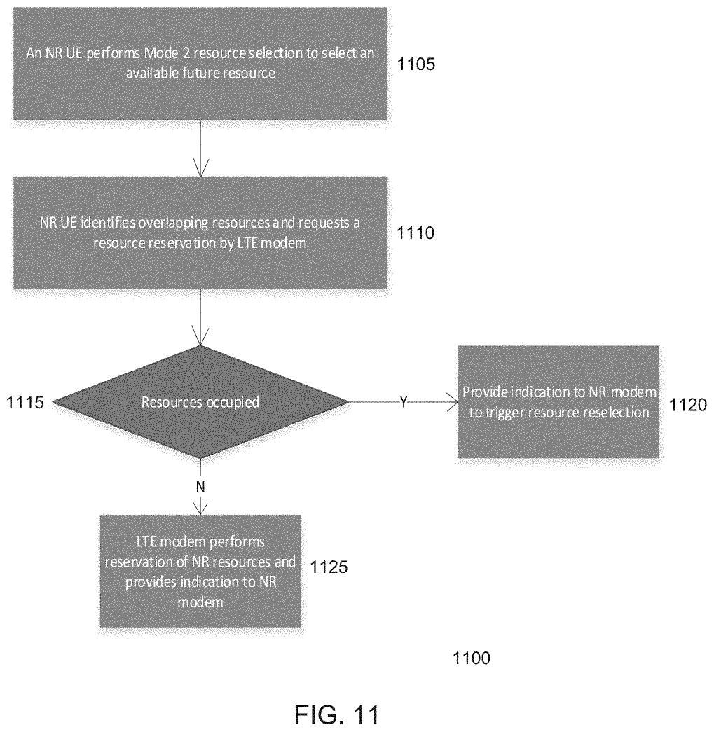

FIG. 11 illustrates a method 1100 of NR reservation in a coexistence band, according to an embodiment. Specifically, higher priority NR UEs can be allowed to perform reservations in a coexistence band (i.e., where NR and LTE transmissions coexist) to increase their chances of resource acquisition. In particular, this coexistence band concerns co-channel coexistence between LTE and NR SLs on the same carrier. Reservations are performed by a collocated LTE modem so as to be avoided by LTE UEs.

In step 1105, the NR UE performs Mode 2 resource selection to select an available future resource.

In step 1110, the NR UE identifies overlapping resources and requests a resource reservation by an LTE modem.

In step 1115, the NR UE determines whether resources are occupied.

If occupied, in step 1120, the NR UE provides this indication to the NR modem to trigger resource reselection.

If unoccupied, in step 1125, the LTE modem performs reservation of NR resources and provides an indication of this reservation to the NR modem.

Thus, in order to avoid impacting legacy LTE devices, an NR UE can utilize its co-located LTE modem to perform either a periodic or an aperiodic future reservation. In this case, the resource reservation will be detected and avoided by other LTE devices. In addition, since this reservation is done by an LTE modem, the reservation is protected against NR devices since LTE is given priority over NR devices.

The following must be taken into consideration when performing these LTE future reservations. The reservations must be located at least T slots away, where T is the time needed for two-way inter-radio access technology (inter-RAT) communication for requesting and confirming the reservation and for payload/control signaling generation. The value of T can be configured by RRC signaling and can depend on the UE capability. In addition, since LTE might need to be given higher priority, this approach can be limited to specific scenarios, such as when the LTE CBR is below a pre-configured threshold.

In the case of NR and LTE coexistence, NR devices will often only be able to detect LTE reservations and accordingly avoid them to reduce collisions. For this to be achieved, an NR device must be able to determine whether a resource is occupied either through energy detection or by decoding a future reservation performed by an SCI. In the case of energy detection, the reference signal received power (RSRP) threshold and the received signal strength indicator (RSSI) threshold for identifying whether a resource is occupied can be dependent on multiple factors including but not limited to NR priority, LTE priority, LTE CBR, NR CBR, and predicted RSSI based on a previous pattern.

For example, the energy detected for a periodic reservation of the same device consistently decreases. Furthermore, an NR UE with high priority can declare a subchannel as unoccupied at pre-configured RSRP/RSSI thresholds that are higher than those considered by a lower priority NR device. In addition, the RSRP/RSSI thresholds can be affected by the CBR levels. For instance, at higher LTE CBR levels, the occupancy thresholds can be reduced to dedicate more resources to the LTE.

Subsequently, once the conditions are met, an NR UE is allowed to access the medium and use the resource for its transmission. When selecting to occupy resources based on detecting periodic LTE reservations, multiple factors must be considered before declaring a future resource as empty or occupied, such as the foregoing factors for identifying whether a resource is occupied, as well as an RSSI threshold for energy detection and an RSRP threshold for SCI detection.

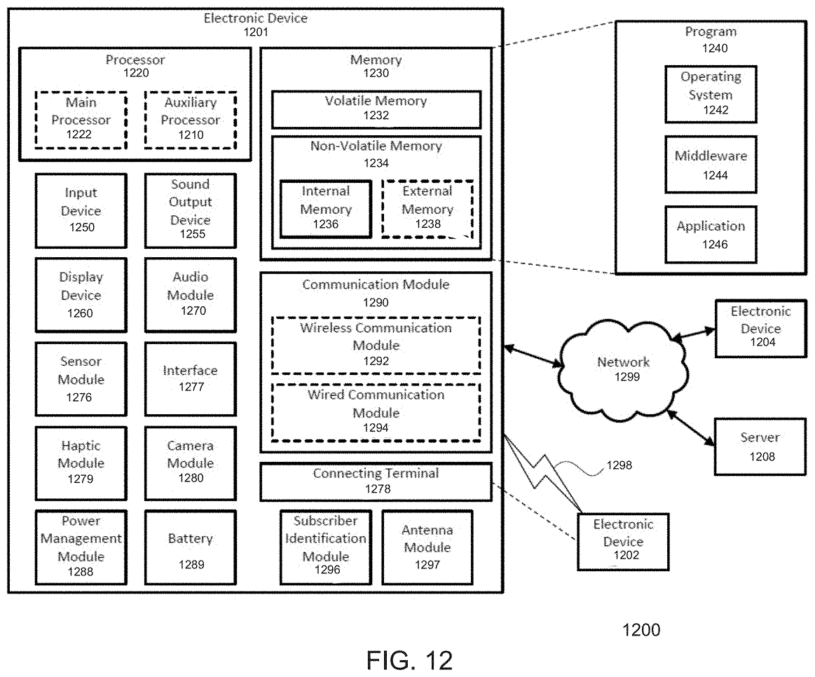

FIG. 12 is a block diagram of an electronic device in a network environment 1200, according to an embodiment. Referring to FIG. 12, an electronic device 1201 in a network environment 1200 may communicate with an electronic device 1202 via a first network 1298 (e.g., a short-range wireless communication network), or an electronic device 1204 or a server 1208 via a second network 1299 (e.g., a long-range wireless communication network). The electronic device 1201 may communicate with the electronic device 1204 via the server 1208. The electronic device 1201 may include a processor 1220, a memory 1230, an input device 1240, a sound output device 1255, a display device 1260, an audio module 1270, a sensor module 1276, an interface 1277, a haptic module 1279, a camera module 1280, a power management module 1288, a battery 1289, a communication module 1290, a subscriber identification module (SIM) card 1296, or an antenna module 1294. In one embodiment, at least one (e.g., the display device 1260 or the camera module 1280) of the components may be omitted from the electronic device 1201, or one or more other components may be added to the electronic device 1201. Some of the components may be implemented as a single integrated circuit (IC). For example, the sensor module 1276 (e.g., a fingerprint sensor, an iris sensor, or an illuminance sensor) may be embedded in the display device 1260 (e.g., a display).

The processor 1220 may execute, for example, software (e.g., a program 1240) to control at least one other component (e.g., a hardware or a software component) of the electronic device 1201 coupled with the processor 1220 and may perform various data processing or computations. For example, the hardware or software component of the electronic device may be included in any of the LTE UEs or NR UEs disclosed herein.

As at least part of the data processing or computations, the processor 1220 may load a command or data received from another component (e.g., the sensor module 1246 or the communication module 1290) in volatile memory 1232, process the command or the data stored in the volatile memory 1232, and store resulting data in non-volatile memory 1234. The processor 1220 may include a main processor 1221 (e.g., a central processing unit (CPU) or an application processor (AP)), and an auxiliary processor 1223 (e.g., a graphics processing unit (GPU), an image signal processor (ISP), a sensor hub processor, or a communication processor (CP)) that is operable independently from, or in conjunction with, the main processor 1221. Additionally or alternatively, the auxiliary processor 1223 may be adapted to consume less power than the main processor 1221, or execute a particular function. The auxiliary processor 1223 may be implemented as being separate from, or a part of, the main processor 1221.

The auxiliary processor 1223 may control at least some of the functions or states related to at least one component (e.g., the display device 1260, the sensor module 1276, or the communication module 1290) among the components of the electronic device 1201, instead of the main processor 1221 while the main processor 1221 is in an inactive (e.g., sleep) state, or together with the main processor 1221 while the main processor 1221 is in an active state (e.g., executing an application). The auxiliary processor 1223 (e.g., an image signal processor or a communication processor) may be implemented as part of another component (e.g., the camera module 1280 or the communication module 1290) functionally related to the auxiliary processor 1223.

The memory 1230 may store various data used by at least one component (e.g., the processor 1220 or the sensor module 1276) of the electronic device 1201. The various data may include, for example, software (e.g., the program 1240) and input data or output data for a command related thereto. The memory 1230 may include the volatile memory 1232 or the non-volatile memory 1234.

The program 1240 may be stored in the memory 1230 as software, and may include, for example, an operating system (OS) 1242, middleware 1244, or an application 1246.

The input device 1250 may receive a command or data to be used by another component (e.g., the processor 1220) of the electronic device 1201, from the outside (e.g., a user) of the electronic device 1201. The input device 1250 may include, for example, a microphone, a mouse, or a keyboard.

The sound output device 1255 may output sound signals to the outside of the electronic device 1201. The sound output device 1255 may include, for example, a speaker or a receiver. The speaker may be used for general purposes, such as playing multimedia or recording, and the receiver may be used for receiving an incoming call. The receiver may be implemented as being separate from, or a part of, the speaker.

The display device 1260 may visually provide information to the outside (e.g., a user) of the electronic device 1201. The display device 1260 may include, for example, a display, a hologram device, or a projector and control circuitry to control a corresponding one of the display, hologram device, and projector. The display device 1260 may include touch circuitry adapted to detect a touch, or sensor circuitry (e.g., a pressure sensor) adapted to measure the intensity of force incurred by the touch.

The audio module 1270 may convert a sound into an electrical signal and vice versa. The audio module 1270 may obtain the sound via the input device 1250 or output the sound via the sound output device 1255 or a headphone of an external electronic device 1202 directly (e.g., wired) or wirelessly coupled with the electronic device 1201.

The sensor module 1276 may detect an operational state (e.g., power or temperature) of the electronic device 1201 or an environmental state (e.g., a state of a user) external to the electronic device 1201, and then generate an electrical signal or data value corresponding to the detected state. The sensor module 1276 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1277 may support one or more specified protocols to be used for the electronic device 1201 to be coupled with the external electronic device 1202 directly (e.g., wired) or wirelessly. The interface 1277 may include, for example, a high-definition multimedia interface (HDMI), a universal serial bus (USB) interface, a secure digital (SD) card interface, or an audio interface.

A connecting terminal 1278 may include a connector via which the electronic device 1201 may be physically connected with the external electronic device 1202. The connecting terminal 1278 may include, for example, an HDMI connector, a USB connector, an SD card connector, or an audio connector (e.g., a headphone connector).

The haptic module 1279 may convert an electrical signal into a mechanical stimulus (e.g., a vibration or a movement) or an electrical stimulus which may be recognized by a user via tactile sensation or kinesthetic sensation. The haptic module 1279 may include, for example, a motor, a piezoelectric element, or an electrical stimulator.

The camera module 1280 may capture a still image or moving images. The camera module 1280 may include one or more lenses, image sensors, image signal processors, or flashes.

The power management module 1288 may manage power supplied to the electronic device 1201. The power management module 1288 may be implemented as at least part of, for example, a power management integrated circuit (PMIC).

The battery 1289 may supply power to at least one component of the electronic device 1201. The battery 1289 may include, for example, a primary cell which is not rechargeable, a secondary cell which is rechargeable, or a fuel cell.

The communication module 1290 may support establishing a direct (e.g., wired) communication channel or a wireless communication channel between the electronic device 1201 and the external electronic device (e.g., the electronic device 1202, the electronic device 1204, or the server 1208) and performing communication via the established communication channel. The communication module 1290 may include one or more communication processors that are operable independently from the processor 1220 (e.g., the AP) and supports a direct (e.g., wired) communication or a wireless communication. The communication module 1290 may include a wireless communication module 1292 (e.g., a cellular communication module, a short-range wireless communication module, or a global navigation satellite system (GNSS) communication module) or a wired communication module 1294 (e.g., a local area network (LAN) communication module or a power line communication (PLC) module). A corresponding one of these communication modules may communicate with the external electronic device via the first network 1298 (e.g., a short-range communication network, such as Bluetooth™, wireless-fidelity (Wi-Fi) direct, or a standard of the Infrared Data Association (IrDA)) or the second network 1299 (e.g., a long-range communication network, such as a cellular network, the Internet, or a computer network (e.g., LAN or wide area network (WAN)). These various types of communication modules may be implemented as a single component (e.g., a single IC), or may be implemented as multiple components (e.g., multiple ICs) that are separate from each other. The wireless communication module 1292 may identify and authenticate the electronic device 1201 in a communication network, such as the first network 1298 or the second network 1299, using subscriber information (e.g., international mobile subscriber identity (IMSI)) stored in the subscriber identification module 1296.

The antenna module 1297 may transmit or receive a signal or power to or from the outside (e.g., the external electronic device) of the electronic device 1201. The antenna module 1297 may include one or more antennas, and, therefrom, at least one antenna appropriate for a communication scheme used in the communication network, such as the first network 1298 or the second network 1299, may be selected, for example, by the communication module 1290 (e.g., the wireless communication module 1292). The signal or the power may then be transmitted or received between the communication module 1290 and the external electronic device via the selected at least one antenna.

Commands or data may be transmitted or received between the electronic device 1201 and the external electronic device 1204 via the server 1208 coupled with the second network 1299. Each of the electronic devices 1202 and 1204 may be a device of a same type as, or a different type, from the electronic device 1201. All or some of operations to be executed at the electronic device 1201 may be executed at one or more of the external electronic devices 1202, 1204, or 1208. For example, if the electronic device 1201 should perform a function or a service automatically, or in response to a request from a user or another device, the electronic device 1201, instead of, or in addition to, executing the function or the service, may request the one or more external electronic devices to perform at least part of the function or the service. The one or more external electronic devices receiving the request may perform the at least part of the function or the service requested, or an additional function or an additional service related to the request and transfer an outcome of the performing to the electronic device 1201. The electronic device 1201 may provide the outcome, with or without further processing of the outcome, as at least part of a reply to the request. To that end, a cloud computing, distributed computing, or client-server computing technology may be used, for example.

While the present disclosure has been described with reference to certain embodiments, various changes may be made without departing from the spirit and the scope of the disclosure, which is defined, not by the detailed description and embodiments, but by the appended claims and their equivalents.

What is claimed is:

1. A method for long term evolution (LTE) carrier determination by a new radio user equipment (NR UE), comprising:
determining whether an LTE carrier includes unused resources for data transmission;
in response to determining the LTE carrier includes the unused resources, performing a collision determination, the collision determination being based at least in part on a randomized likelihood that transmissions of the NR UE on the LTE carrier will collide with transmissions of one or more other NR UEs on the LTE carrier; and
based on the collision determination, performing a transmission delay, the transmission delay occurring during a random back off period duration.

2. The method of claim 1, further comprising:
determining whether a packet delay budget has expired; and
in response to determining that the packet delay budget has expired, dropping the data transmission.

3. The method of claim 2,
wherein the collision determination is a first collision determination and the method further comprises transmitting data in response to a second collision determination that the transmissions of the first NR UE on the LTE carrier will not collide with the transmissions of the one or more second NR UEs on the LTE carrier.

4. The method of claim 3,
wherein the data is transmitted according to an NR frame structure of the LTE carrier based at least in part on one or more LTE coexistence enabled resource pools.

5. The method of claim 4, wherein the data transmission includes at least one transport block.

6. The method of claim 1,
wherein the determination that the LTE carrier includes the unused resources for data transmission is based at least in part on energy detection at a beginning of an LTE subframe indicating that no LTE transmission was performed on a first NR slot.

7. The method of claim 6,
wherein the indication that no LTE transmission was performed on the first NR slot is based at least in part on an inference that at least a second NR slot overlapping with the LTE subframe will be unused and determines the second NR slot as being free.

8. The method of claim 1, further comprising monitoring, by the NR UE, the LTE carrier when the NR UE has data to transmit,
wherein determining whether the LTE carrier includes the unused resources for data transmission is based on the monitoring.

9. A new radio user equipment (NR UE), comprising:
at least one processor; and
at least one memory operatively connected with the at least one processor, the at least one memory storing instructions, which when executed, instruct the at least one processor to perform a method including:
determining whether a long term evolution (LTE carrier includes unused resources for data transmission;
in response to determining the LTE carrier includes the unused resources, performing a collision determination, the collision determination being based at least in part on a randomized likelihood that transmissions of the NR UE on the LTE carrier will collide with transmissions of one or more other NR UEs on the LTE carrier; and
based on the collision determination, performing a transmission delay, the transmission delay occurring during a random back off period duration.

10. The NR UE of claim 9,
wherein the at least one memory stores instructions, which when executed, further instruct the at least one processor to:
determine whether a packet delay budget has expired; and
in response to determining that the packet delay budget has expired, drop the data transmission.

11. The NR UE of claim 10,
wherein data is transmitted when it is determined that the transmissions of the NR UE on the LTE carrier will not collide with the transmissions of the one or more other NR UEs on the LTE carrier.

12. The NR UE of claim 11,
wherein the LTE carrier includes one or more LTE coexistence enabled resource pools which the NR UE uses to transmit the data based on an NR frame structure.

13. The NR UE of claim 12,
wherein the data transmission includes at least one transport block.

14. The NR UE of claim 9,
wherein the NR UE determines that the LTE carrier includes the unused resources for data transmission by performing energy detection at a beginning of an LTE subframe to identify that no LTE transmission was performed on a first NR slot.

15. The NR UE of claim 14,
wherein, when identifying that no LTE transmission was performed on the first NR slot, the NR UE infers that at least a second NR slot overlapping with the LTE subframe will be unused and determines the second NR slot as being free.

16. The NR UE of claim 9,
wherein the at least one memory stores instructions, which when executed, further instruct the at least one processor to monitor the LTE carrier when the NR UE has data to transmit, and
wherein determining whether the LTE carrier includes the unused resources for data transmission is based on the monitoring.

17. A new radio user equipment (NR UE) for NR vehicle-to-everything (NR V2X) transmissions, comprising:
at least one processor; and
at least one memory operatively connected with the at least one processor, the at least one memory storing instructions, which when executed, instruct the at least one processor to perform a method including:
performing energy detection on a first symbol at a beginning of a long term evolution (LTE) subframe;
switching from the energy detection to an NR transmission on a second symbol or on the first symbol after the energy detection is performed; and
performing the NR transmission on an NR slot for a remainder of the LTE subframe.

18. The NR UE of claim 17,
wherein the energy detection is switched to the NR transmission in a switching gap on the first symbol or the second symbol.

19. The NR UE of claim 18,
wherein the remainder of the LTE subframe is used for transmitting orthogonal frequency division multiplexing (OFDM) symbols of the NR slot.

20. The NR UE of claim 19,
wherein multiple subcarrier spacings are used within a same band for the LTE subframe and the NR slot.
